(19) United States
(12) Patent Application Publication
(10) Pub. No.: US 2014/0004027 A1
(43) Pub. Date: Jan. 2, 2014

(54) TITANIA CARRIER FOR SUPPORTING CATALYST, MANGANESE OXIDE-TITANIA CATALYST COMPRISING THE SAME, APPARATUS AND METHOD FOR MANUFACTURING THE TITANIA CARRIER AND MANGANESE OXIDE-TITANIA CATALYST, AND METHOD FOR REMOVING NITROGEN OXIDES

(71) Applicants: Jong Soo Jurng, Seoul (KR); Eun Seuk Park, Seongnam-si (KR); Sung Min Chin, Ujeongbu-si (KR); Woo Joon Cha, Gimpo-si (KR)

(72) Inventors: Jong Soo Jurng, Seoul (KR); Eun Seuk Park, Seongnam-si (KR); Sung Min Chin, Ujeongbu-si (KR); Woo Joon Cha, Gimpo-si (KR)

(21) Appl. No.: 13/686,141

(22) Filed: Nov. 27, 2012

(30) Foreign Application Priority Data
Jun. 27, 2012 (KR) 10-2012-0069008

(51) Int. Cl. B01J 21/06

(52) U.S. Cl. CPC B01J 21/063
USPC 423/239.1; 423/610; 502/324; 422/129; 428/402

(57) ABSTRACT

Provided are a titania carrier for supporting a catalyst for removing nitrogen oxides, a manganese oxide-titania catalyst comprising the same, an apparatus and a method for preparing the same, and a method for removing nitrogen oxides. More particularly, provided are a titania carrier having a specific surface area of 100 m²/g-150 m²/g, an average pore volume of 0.1 cm³/g-0.2 cm³/g, and an average particle size of 5 nm-20 nm, and an apparatus and method for preparing the same. Provided also are a manganese oxide-titania catalyst comprising the titania carrier and manganese oxide supported thereon, a method for preparing the same, and a method for removing nitrogen oxides using the catalyst. The catalyst has high activity and dispersibility, and thus provides excellent denitrogenation efficiency even in a low temperature range of about 200° C.

### CROSS-REFERENCE TO RELATED APPLICATION

This application claims priority to Korean Patent Application No. 10-2012-0069008, filed on Jun. 27, 2012, and all the benefits accruing therefrom under 35 U.S.C. §119, the contents of which in its entirety are herein incorporated by reference.

### BACKGROUND

1. Field

The present disclosure relates to a titania carrier for supporting a catalyst, a manganese oxide-titania catalyst comprising the same, an apparatus and a method for preparing the same, and a method for removing nitrogen oxides. More particularly, the present disclosure relates to a titania carrier for supporting a catalyst, obtained via chemical vapor condensation, and thus providing a high specific surface area, uniform nanoparticle size and excellent dispersibility of a supported catalyst, and particularly exhibiting excellent denitrogenation efficiency even in a low temperature range of about 200° C., as well as to a manganese oxide-titania catalyst comprising the same, an apparatus and a method for preparing the same, and a method for removing nitrogen oxides using the manganese oxide-titania catalyst.

2. Description of the Related Art

Exhaust gas generated from incineration plants, power plants and petrochemical plants comprises nitrogen oxides (NOₓ). A large proportion of such nitrogen oxides (NOₓ) contained in exhaust gas is occupied by NO, NO₂, etc., and such nitrogen oxides (NOₓ) function as a main cause of acid rain and air pollution such as photochemical smog.

Typical methods for removing nitrogen oxides (NOₓ) contained in exhaust gas comprise a fuel denitrogenation method in which generation of nitrogen oxides (NOₓ) is reduced by removing them from fossil fuel in advance, a method for reducing generation of nitrogen oxides (NOₓ) by improving a combustion condition, and a selective catalytic reduction (SCR) method in which nitrogen oxides are reacted selectively with ammonia on the surface of a catalyst and reduced into nitrogen and water. Among such methods, SCR shows the highest nitrogen oxide (NOₓ) removal efficiency.

Therefore, such an SCR method has been used commercially in most incineration plants or thermal power plants in practice. A V₂O₅—TiO₂ catalyst obtained by supporting vanadium oxide (V₂O₅) on titania (TiO₂) is used frequently as a catalyst. However, in the case of such a catalyst having vanadium oxide (V₂O₅) supported thereon, nitrogen oxide (NOₓ) removal efficiency may be degraded and side reactions may occur due to poisoning or wearing of the catalyst. In addition, ammonium salt may be produced due to the presence of unreacted ammonia (NH₃) slip in exhaust gas, thereby causing corrosion of the apparatus used for the method. Further, the method has a narrow reaction range of 300° C.-400° C., which is a relatively high temperature, leading to additional energy cost for the operation of an SCR method. Under these circumstances, there has been a need for a method for preparing a catalyst capable of removing nitrogen oxides (NOₓ) in a low temperature range, for example, about 200° C. from the viewpoint of cost efficiency and technological success.

Recently, methods for preparing a catalyst having a manganese oxide supported thereon have been studied actively. Such a manganese oxide-supported catalyst has different crystal types of MnO, MnO₂, Mn₂O₃, Mn₃O₄, etc., and thus has various active sites on the surface of a catalyst. As a result, such a manganese oxide-supported catalyst has higher nitrogen oxide (NOₓ) removal efficiency in a relatively low temperature range as compared to vanadium oxide (V₂O₅)-supported catalyst, and has a high specific surface area that allows reduction of NH₃ slip.

For example, Korean Laid-Open Patent Publication Nos. 10-2010-0001315 and 10-2011-0034400 disclose a catalyst for removing nitrogen oxides, which comprises manganese oxide supported thereon, and a method for removing nitrogen oxides using the same.

In general, catalysts for removing nitrogen oxides have been prepared by a wet process. However, such a wet process shows a limitation in selecting the composition of a catalyst to be produced, and has a difficulty in preparing a high-purity uniform catalyst. In addition, such a process requires a relatively large number of operations, comprising dissolution, evaporation, drying, pulverization and calcining. Thus, it takes a long time of several days or more to prepare a catalyst by such a process. Further, the prepared catalyst has a low specific surface area and dispersibility. As a result, the final catalyst provides low nitrogen oxide removal efficiency, and thus has poor applicability to actual commercial plants.

In addition to the wet process (liquid phase process), more recently, many attentions have been given to a chemical vapor condensation process comprising evaporating a precursor material by using its vapor pressure and forming particles in a hot reaction furnace by using collision between gas molecules. Such a chemical vapor condensation process induces reactions with various gases, unlike the conventional wet process, thereby realizing a broad selection of catalyst compositions and simplified manufacturing process, and allowing production of high-purity uniform nanoparticles.

The catalyst according to the related art has poor active sites and low denitrogenation efficiency. In addition, the carrier (support) on which a catalyst is to be supported significantly affects the quality of a catalyst. However, the carrier according to the related art has a low specific surface area and catalyst dispersibility, resulting in low denitrogenation efficiency, particularly in a low temperature range of about 200° C.

### REFERENCES OF THE RELATED ART

### Patent Document

Korean Laid-Open Patent Publication No. 10-2010-0001315
Korean Laid-Open Patent Publication No. 10-2011-0034400

### SUMMARY

The present disclosure is directed to providing a titania (TiO₂) carrier for supporting a catalyst, obtained by chemical vapor condensation, and thus having a high specific surface area, uniform nanoparticle size and excellent dispersibility upon supporting a catalyst, and particularly exhibiting excellent denitrogenation efficiency in a low temperature range of about 200° C. The present disclosure is also directed to providing a manganese oxide-titania catalyst comprising the same, a method and apparatus for preparing the same, and a method for removing nitrogen oxides using the manganese oxide-titania catalyst.

In one aspect, there is provided a titania carrier for supporting a catalyst for removing nitrogen oxides, the titania carrier being obtained by chemical vapor condensation, and having a specific surface area of 100 m²/g-150 m²/g, an average pore volume of 0.1 cm³/g-0.2 cm³/g, and an average particle size of 5 nm-20 nm.

In another aspect, there is provided an apparatus for preparing a titania carrier for supporting a catalyst for removing nitrogen oxides, comprising: a titania precursor supplying unit in which a titania precursor is allowed to vaporize and supplied to a reaction unit; an oxygen supplying line through which an oxygen source is supplied to a reaction unit; a reaction unit in which the titania precursor supplied from the titania precursor supplying unit is reacted to produce titania particles; and a recovering unit in which the titania particles produced at the reaction unit are cooled and collected, wherein the recovering unit comprises a cooling system for cooling the titania particles introduced from the reaction unit, and a collecting system for collecting the titania particles cooled at the cooling system, and the cooling system has a turbulence-forming section in a flow path through which the titania particles are passed.

In still another aspect, there is provided a method for preparing a titania carrier, comprising: vaporizing a titania precursor; reacting the vaporized titania precursor to produce titania particles; and recovering the titania particles produced from the reacting operation, wherein the recovering operation comprises cooling the titania particles produced from the reacting operation and collecting the cooled titania particles, wherein the cooling operation is carried out by using a cooling system having a turbulence-forming section on a flow path of the titania particles produced from the reacting operation.

In still another aspect, there is provided a manganese oxide-titania catalyst for removing nitrogen oxides, obtained by supporting manganese oxide onto the titania carrier disclosed herein, and having a specific surface area of 100 m²/g-280 m²/g, and an average pore volume of 0.12 cm³/g-0.38 cm³/g. The manganese oxide may be supported in an amount of 1-15 wt % based on the total weight of the catalyst.

In still another aspect, there is provided a method for preparing a manganese oxide-titania catalyst for removing nitrogen oxides, comprising: providing a titania carrier by the method disclosed herein; and mixing the titania carrier with a solution in which a manganese precursor is dissolved, followed by drying and calcining.

In yet another aspect, there is provided a method for removing nitrogen oxides using the manganese oxide-titania catalyst.

The titania (TiO₂) carrier obtained by the method disclosed herein has a high specific surface area, uniform nanoparticle size, improved pore volume and excellent dispersibility upon supporting a catalyst. In addition, the manganese oxide-titania catalyst comprising the titania carrier disclosed herein has high catalytic activity and dispersibility, and particularly exhibits excellent denitrogenation efficiency in a low temperature range of about 200° C.

### BRIEF DESCRIPTION OF THE DRAWINGS

FIG. 1 is a schematic view illustrating an apparatus for preparing a titania carrier according to an embodiment;

FIG. 2 is a schematic sectional view illustrating a particular embodiment of a cooling system consisting of an apparatus for preparing a titania carrier according to an embodiment;

FIG. 3 is a photograph of a cooling system used in an apparatus according to an embodiment;

FIGS. 4A, 4B, 4C, and 4D are high resolution transmission electron microscopy (HRTEM) images of the catalysts according to Examples and Comparative Examples;

FIGS. 5A, 5B, 5C, and 5D are EDS mapping images of the catalysts based on energy spectrometry according to Examples and Comparative Examples;

FIG. 6 and FIG. 7 are graphs of hydrogen temperature-programmed reduction (H₂-TPR) carried out to determine the reduction capability of each of the catalysts according to Examples and Comparative Examples;

FIG. 8 is a graph showing the results of evaluation of nitrogen oxide removal efficiency of each of the catalysts as a function of treatment temperature according to Examples and Comparative Examples; and

FIG. 9 is a graph showing the results of evaluation of nitrogen oxide removal efficiency of each of the catalysts as a function of molar ratio of nitrogen monoxide to ammonia according to Examples and Comparative Examples.

### DETAILED DESCRIPTION OF MAIN ELEMENTS

100: titania precursor supplying section 120: vaporization tank
140: precursor supplying line 160: carrier gas supplying line
200: oxygen supplying line 300: reaction unit
310: reaction tube 320: heat supplying unit
400: recovering unit 410: cooling system
412: external tube 414: internal tube
414a: turbulence-forming section

### DETAILED DESCRIPTION

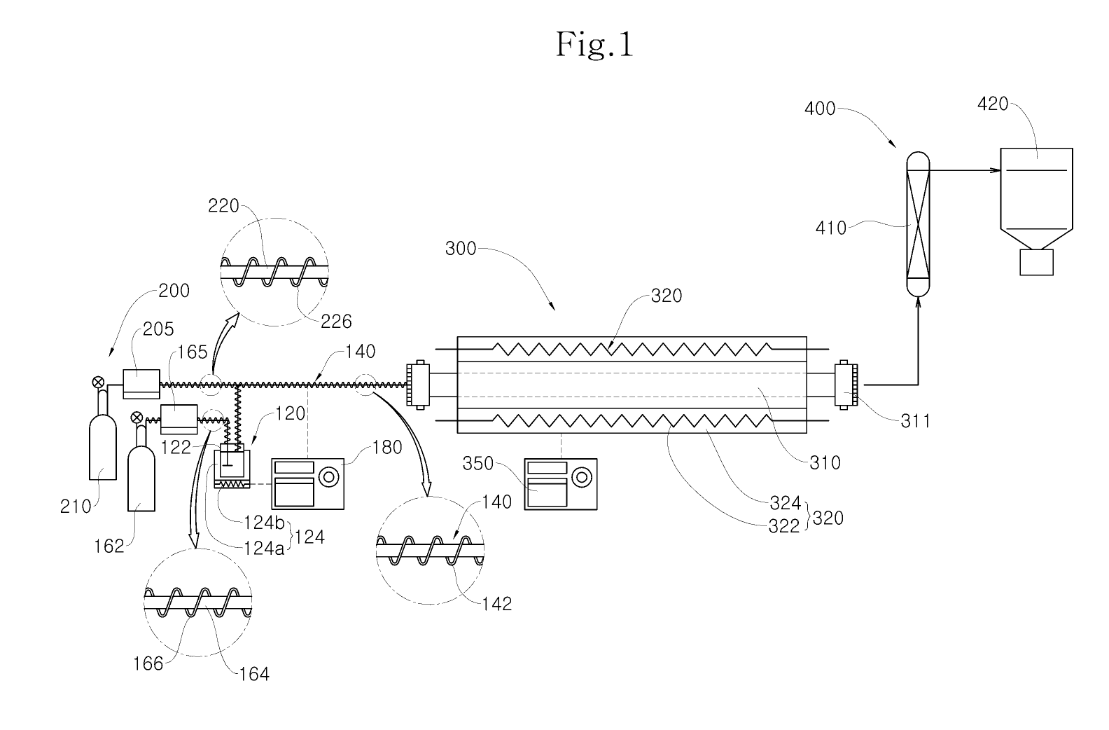

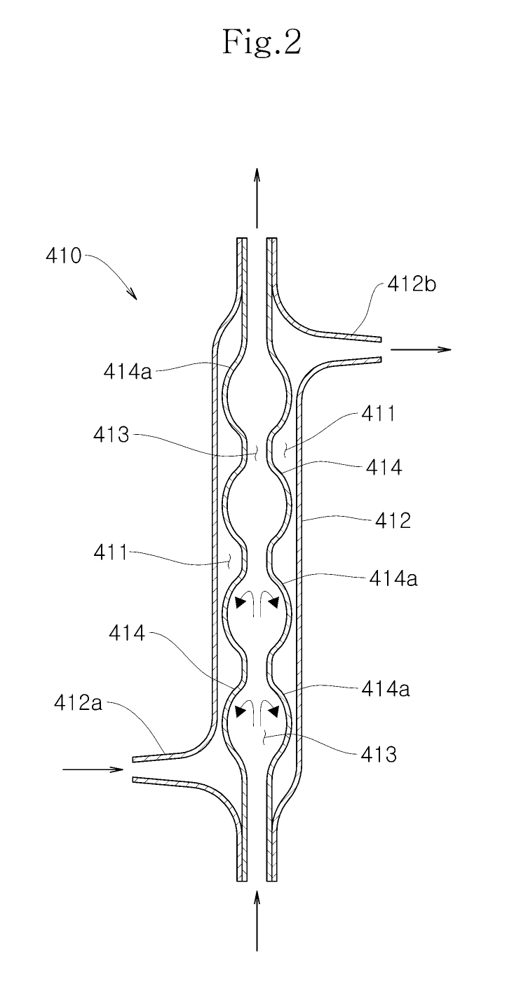

Exemplary embodiments now will be described more fully hereinafter with reference to the accompanying drawings, in which exemplary embodiments are shown. First, the apparatus and method for preparing a titania (TiO₂) carrier will be described, and then a manganese oxide-titania catalyst and a method for preparing the same will be described. Further, a method for removing nitrogen oxides will be described. FIG. 1 is a schematic view illustrating an apparatus for preparing a titania carrier according to an embodiment, and FIG. 2 is a schematic sectional view illustrating a particular embodiment of a cooling system consisting of an apparatus for preparing a titania carrier according to an embodiment.

Referring to FIG. 1 and FIG. 2, the apparatus for preparing a titania (TiO₂) carrier comprises: a titania precursor supplying unit 100 in which a titania (TiO₂) precursor is allowed to vaporize (volatilize) and supplied to a reaction unit 300; an oxygen supplying line 200 through which an oxygen source is supplied to a reaction unit 300; a reaction unit 300 in which the titania precursor supplied from the titania precursor supplying unit 100 is reacted to produce titania particles; and a recovering unit 400 in which the titania particles produced at the reaction unit 300 are cooled and collected.

The titania precursor supplying unit 100 is not particularly limited, as long as it allows a titania precursor to vaporize (volatilize) so as to be supplied to the reaction unit 300. In other words, in the titania precursor supplying unit 100, a vaporized product of titania precursor is produced, and then is conveyed and supplied to the reaction unit 300. The vaporized product of titania precursor is forced to be conveyed and supplied through a carrier member. For example, the carrier member may be selected from a carrier gas, pump and blower fan. More particularly, a carrier gas may be used advantageously as described hereinafter.

According to an embodiment, the titania precursor supplying unit 100 may comprise a vaporization tank 120 in which the titania precursor is vaporized, a precursor supplying line 140 through which the vaporized product of titania precursor is conveyed and supplied to the reaction unit 300, and a carrier gas injection line 160 through which a carrier gas is introduced to the vaporization tank 120 as a carrier member.

The vaporization tank 120 may consist of various forms. For example, the vaporization tank 120 may comprise a bubbler 122 in which a titania precursor is received and vaporized, and a heating source 124 applying heat to the bubbler 122.

The bubbler 122 may have various container shapes, such as a cylindrical or polyprismatic shape. In addition, a plate may be installed inside the bubbler 122, and such a plate may have a single layer or two or more layers.

The heating source 124 is not particularly limited, as long as it supplies heat to the bubbler 122. For example, the heating source 124 may be selected from a heating wire or band heater to which electric power is applied to emit heat. The heating source 124, such as a heating wire or band heater, may be installed in such a manner that it is wound around the outer circumference of the wall body of the bubbler 122 or it is embedded inside the bubbler 122.

Particularly, the heating source 124 may comprise an oil bath maintaining high temperature. More particularly, the heating source 124 may comprise an oil bath 124a in which oil is received, and a heating member 124b for heating the oil. As shown in FIG. 1, a heating wire may be used as the heating member 124b. When using the oil bath 124a containing hot oil as the heating source 124 applying heat to the bubbler 122, it is possible to prevent rapid warming of the bubbler 122 and to supply heat uniformly to the whole regions of the bubbler 122.

The vaporized product of titania precursor generated at the vaporization tank 120 is conveyed and supplied to the reaction unit 300 along the precursor supplying line 140. The precursor supplying line 140 is connected to the vaporization tank 120 at one side and to the reaction unit 300 at the other side. More particularly, one side of the precursor supplying line 140 is connected to the bubbler 122 of the vaporization tank 120, and the other side thereof may be coupled with the reaction tube 310 of the reaction unit 300 through a coupling member 311 such as a flange.

According to an embodiment, the precursor supplying line 140 may be provided with a constant temperature-maintaining member 142 preventing the condensation of the vaporized product of titania precursor. The constant temperature-maintaining member 142 may be one capable of preventing the vaporized product of titania precursor from being condensed while it is conveyed along the supplying line 140. The constant temperature-maintaining member 142 is a heat-insulating or heating member. For example, the constant temperature-maintaining member 142 may be selected from a heat-insulating material, heating wire or band heater formed on the outer circumference of the precursor supplying line 140. More particularly, the constant temperature-maintaining member 142 may be selected from a heating wire wound on the outer circumference of the precursor supplying line 140.

In addition, the carrier gas injection line 160 is for use in injecting a carrier gas to the vaporization tank 120. The carrier gas serves as a carrier that allows the vaporized product of titania precursor to be conveyed and supplied easily to the reaction unit 300. Particularly, the vaporized product of titania precursor generated at the vaporization tank 120 is conveyed and supplied to the reaction unit 300 along the precursor supplying line 140 by the carrying operation of the carrier gas.

The carrier gas injection line 160 is not particularly limited, as long as it allows injection of a carrier gas to the vaporization tank 120. For example, the carrier gas injection line 160 comprises a bombe 162 in which a carrier gas is stored, and an injection line 164 providing a flow path through which the carrier gas stored in the bombe 162 is conveyed and supplied to the vaporization tank 120. The injection line 164 is connected to the bombe 162 at one end and is embedded in the bubbler 122 of the vaporization tank 120 at the other end.

The carrier gas is not particularly limited, as long as it is capable of carrying the vaporized product of titania precursor. Although there is no particular limitation, the carrier gas may be any one selected from the group consisting of argon (Ar), nitrogen (N₂), helium (He), oxygen (O₂) and air, or a mixed gas of at least two of them. More particularly, the carrier gas may be argon (Ar).

The carrier gas injection line 160 may further comprise a mass flow controller (MFC) 165 controlling the injection flux of the carrier gas. As shown in FIG. 1, such a mass flow controller 165 may be provided on the injection line 164. The feed flux of the vaporized product of titania precursor supplied to the reaction unit 300 may be controlled by the injection flux of the carrier gas. In another embodiment, the feed flux of the vaporized product of titania precursor may be controlled by a flux controller (not shown) provided on the precursor supplying line 140.

In addition, the carrier gas may be maintained at an adequate temperature. When the carrier gas is injected to the vaporization tank 120 at an excessively low temperature, the vaporized product of titania precursor in the vaporization tank 120 may be condensed to produce liquid mist. Therefore, the carrier gas may be maintained approximately at the same temperature as the vaporized product of titania precursor in the vaporization tank 120. For this, the carrier gas injection line 160 may further comprise a heat insulating member or heating member. For example, such a heat insulating or heating member may be provided on the bombe 162. Particularly, the heat insulating or heating member may be provided on the injection line 164 through which the carrier gas flows. In addition, the heat insulating or heating member may be selected from a heat insulating material, heating wire and band heater. In FIG. 1, a heating wire 166 is formed on the injection line 164 as a heating member.

Further, the titania precursor supplying unit 100 may further comprise a temperature controller 180. The temperature controller 180 controls the heating source 124 of the vaporization tank 120 so that an adequate amount of heat is supplied to the bubbler 122. The temperature of the heating source 124 controlled by the temperature controller 180 may vary with the particular type of the titania precursor. The temperature of the heating source 124 may be determined by the boiling point of the titania precursor. For example, the temperature may be controlled to 80-110° C. In addition, the temperature controller 180 controls not only the temperature of the vaporization tank 120 but also that of the vaporized product of titania precursor flowing through the precursor supplying line 140 and/or that of the carrier gas. In other words, the temperature controller 180 may control the temperature of the constant temperature maintaining member 142 installed on the precursor supplying line 140 and/or the temperature of the heating wire 166 formed on the carrier gas injection line 164.

Herein, the titania precursor is not particularly limited, as long as it is a compound containing titanium (Ti) in its molecule. The titania precursor contains at least titanium (Ti) in its molecule and may further contain an oxygen atom (O). For example, although there is no particular limitation, the titania precursor may be at least one selected from titanium salts and organotitanium compounds. Particular examples of the titanium salts comprise titanium tetrachloride (TiCl₄). Particularly, the titania precursor may be selected from organotitanium compounds, comprising titanium alkoxides.

More particularly, the titania precursor may be at least one selected from the group consisting of titanium alkoxides, such as titanium tetramethoxide, titanium tetraethoxide, titanium tetra-n-propoxide, titanium tetra-iso-propoxide and titanium tetra-n-butoxide. Among those, titanium tetra-iso-propoxide (TTIP, Ti[OCH(CH₃)₂]₄) is particularly useful.

The oxygen supplying line 200 is for use in supplying an oxygen source to the reaction unit 300. According to an exemplary embodiment, the oxygen supplying line 200 may comprise a storage tank 210 in which an oxygen source is stored, and an oxygen conveying line 220 through which the oxygen source stored in the storage tank 210 is supplied. The oxygen conveying line 220 is connected to the storage tank 210 at one side and to the reaction tube 310 of the reaction unit 300 at the other side. Particularly, as shown in FIG. 1, the oxygen conveying line 220 may be connected to the storage tank 210 at one side and connected integrally to the precursor supplying line 140 at other side.

In the storage tank 210, at least one oxygen source, such as one selected from oxygen (O₂) and air, may be charged and stored. In addition, the oxygen supplying line 200 may further comprise a mass flow controller (MFC) 205 controlling the feed flux of the oxygen source, and such an MFC 205 may be provided on the oxygen conveying line 220 as shown in FIG. 1.

Further, the oxygen source may be maintained at an adequate temperature. Particularly, when the oxygen source is supplied to the reaction unit 300 at an excessively low temperature, it may cause condensation of the vaporized product of titania precursor generated at the titania precursor supplying unit 100 upon the contact with the latter. Thus, the oxygen source may be maintained approximately at the same temperature as the vaporized product of titania precursor. For this, the oxygen supplying line 200 may further comprise a heat insulating member or heating member. For example, the storage tank 210 may be provided with a heat insulating member or heating member, or the oxygen conveying line 220 may be provided with a heat insulating member or heating member. The heat insulating member or heating member may be selected from a heat insulating material, heating wire and band heater as mentioned above. In FIG. 1, a heating wire 226 formed on the oxygen conveying line 220 is exemplified as a heating member.

The reaction unit 300 generates titania particles from the vaporized product of titania precursor introduced thereto. Particularly, the reaction unit 300 is maintained at high temperature so that titania particles are produced via chemical vapor synthesis. The reaction unit 300 comprises a reaction tube 310 in which reaction occurs, and a heat supplying member 320 supplying heat to the reaction tube 310 at high temperature.

The reaction tube 310 has a tubular shape and may comprise a metallic or ceramic material. Particularly, the reaction tube 310 may be selected from an alumina tube, quartz tube and mullite tube.

The heat supplying member 320 may be one capable of supplying heat to the reaction tube 310 and have various forms. For example, the heat supplying member 320 may comprise a heating wire or band heater emitting heat under the application of electric power. The heat supplying member 320 such as a heating wire or band heater may be formed along the length of the reaction tube 310 singly or in groups of two or more. In a variant, the heat supplying member 320 may be wound spirally on the outer circumference of the reaction tube 310. In addition, as shown in FIG. 1, the heat supplying member 320 may be selected from an externally warmed electric furnace having a heating wire 322 embedded in a thermally conductive coating body 324, and the like. In another variant, the heat supplying member 320 may be a hot fluid flowing through the double jacket-type reaction tube 310. The heat supplying member 320 is not limited to the above-described embodiment, and any heat supplying member capable of supplying heat to the reaction tube 310 may be used.

In addition, the reaction unit 300 may further comprise a temperature controller 350. The temperature controller 350 may control the heat supplying member 320 to adjust the internal temperature of the reaction tube 310 to an adequately high temperature. For example, the internal temperature of the reaction tube 310 may be maintained at 700-1200° C. Further, the reaction tube 310 may be maintained at ambient pressure (atmospheric pressure) or may be present in a vacuum state below ambient pressure by a depressurization chamber (not shown).

The titania particles prepared at the reaction unit 300 are nano-sized fine particles, and are collected and recovered at a recovering unit 400. In other words, the titania particles prepared at the reaction tube 310 are introduced to the recovering unit 400 under the carrying operation of the carrier gas and collected/recovered at the recovering unit 400.

The recovering unit 400 comprises a cooling system 410 in which the product ejected from the reaction unit 300 is cooled(condensed), and a particle collecting system 420 collecting and recovering the titania particles contained in the product. The particle collecting system 420 is not particularly limited, as long as it is capable of collecting and recovering the titania particles. For example, the particle collecting system may be selected from a cyclone-type collecting system, gravity-settling type collecting system and a filtering type collecting system.

The cooling system 410 cools (condenses) the hot product (i.e. fluid containing the titania particles) ejected from the reaction unit 300. The cooling system 410 may be coupled with the reaction tube 310 of the reaction unit 300 through a coupling member 311 such as a flange. The cooling system 410 comprises a ball-like turbulence-forming section 414a for example in a ball-like shape in accordance with an embodiment. The cooling system 410 may be a conventional system, such as a thermophoretic type system. More particularly, when using a cooling system 410 that has a general structure, such as a system having a thermophoretic type linear cooling tube, cooling efficiency for the hot gas containing the titania particles may be lowered and the characteristics of the titania particles may be degraded. Thus, according to an embodiment, a rapid cooling system 410 comprising a turbulence-forming section 414a, such as a ball-like shape may be used. FIG. 2 shows a sectional schematic view of such a rapid cooling system 410 according to an embodiment.

Referring to FIG. 2, the rapid cooling system 410 has a double tubular shape comprising an external tube 412 and an internal tube 414 formed inside the external tube 412. In addition, a coolant flow path 411 through which a coolant flows is formed between the internal tube 414 and the external tube 412, and the external tube 412 is provided with a coolant inlet 412a and a coolant outlet 412b. As shown in FIG. 2, the internal tube 414 has a fluid flow path 413 through which a hot fluid (fluid containing hot titania particles) passes, and is provided with a turbulence-forming section 414a against which the fluid bumps to generate turbulence. The turbulence-forming section 414a is any one capable of forming turbulence. For example, it has a ball-like shape as shown in FIG. 2. More particularly, the turbulence-forming section 414a has a ball-like shape with the internal tube 414 protruding out toward the exterior, and may have a circular or elliptic sectional shape. The turbulence-forming section 414a may be formed along the length of the internal tube 414 singly or in groups of two or more.

Therefore, the coolant introduced through the coolant inlet 412a flows along the coolant flow path 411 formed between the internal tube 414 and the external tube 412, while it allows cooling of the hot fluid (titania particles) passing through the fluid flow path 413 of the internal tube 414. In addition, as shown in FIG. 2, the fluid introduced to the fluid flow path 413 naturally has turbulence due to the turbulence-forming section 414a. As a result, the fluid or hot titania particles are cooled rapidly so that their particle characteristics are improved and the condensation recovery ratio is increased.

Particularly, since the fluid introduced to the internal tube 414 has turbulence due to the ball-like turbulence-forming section 414a, it has a long time (i.e. contact time with the coolant) to be in contact with the wall surface of the internal tube 414. In addition, the introduced fluid is in contact with the coolant over a large surface area due to the turbulence-forming section 414a. In other words, the turbulence-forming section 414a has a ball-like shape as shown in FIG. 2, and thus causes an increase in contact area between the fluid (titania particles) and the coolant. As a result, the hot titania particles are cooled rapidly in a short time to increase the condensation recovery ratio, while improving the particle characteristics, such as specific surface area and pore volume by virtue of such rapid cooling (condensation).

The recovering unit 400 may comprise one or two or more such rapid cooling systems 410. In other words, a single rapid cooling system 410 or two or more such rapid cooling systems connected in series may be used to facilitate cooling. In addition, there is no limitation in length of the rapid cooling system 410. As shown in FIG. 1, a particle collecting system 420 is linked to the rear end of the rapid cooling system 410.

The method for preparing a titania carrier will now be described.

The method for preparing a titania carrier disclosed herein comprises: vaporizing a titania precursor; reacting the vaporized titania precursor to form titania particles; and recovering the titania particles. The method is carried out in a continuous mode. The method for preparing a titania carrier may be carried out in the apparatus as described hereinbefore. Each operation forming the method will be described in detail.

Vaporization

First, a titania precursor is vaporized (volatilize) to produce a vaporized product. The vaporization may be performed at the precursor supplying unit 100 of the above-described apparatus. As used herein, vaporization (volatilization) does not mean merely a thermal conversion from a liquid (solid) titania precursor into a complete gas state but also comprises atomization to an effervescent state.

In addition, particular examples of the titania precursor are the same as described above. In the vaporizing operation, the titania precursor is vaporized (or atomized) into a vapor phase so as to obtain high reactivity in the reaction unit 300. When the titania precursor is not vaporized (or atomized) but supplied to the hot reaction unit 300 in a liquid phase, the yield (productivity) of titania particles in the reaction unit 300 may be lowered and the particle characteristics (particle size and dispersibility) may be degraded.

The vaporization operation may be carried out by heating the titania precursor to an adequate temperature depending on the particular type and amount of the titania precursor. Although there is no particular limitation, the titania precursor may be vaporized (or atomized) by heating it to a temperature of 50-200° C. For example, when using an organic compound, such as titanium alkoxide, as a titania precursor, vaporization may be carried out at a temperature of 80-110° C. considering the boiling point of the compound. More particularly, vaporization may be carried out by maintaining the temperature of the bubbler 122 of the precursor supplying unit 100 at the above temperature range. When the temperature is excessively low, the vaporized product is generated at a low concentration, resulting in a drop in productivity (yield) of titania particles. On the other hand, when the temperature is excessively high, the vaporized product is generated at a high concentration, resulting in degradation of particle characteristics (e.g. formation of excessively large titania particles).

Reaction

Titania particles are produced from the vaporized product of titania precursor. Particularly, the vaporized product of titania precursor and an oxygen source are supplied to the reaction unit 300 to produce titania particles. The oxygen source serves as a source of oxygen for titania, as well as functions to protect the vaporized product of titania precursor from the ingredients (e.g. reaction gas introduced from the exterior, or the like) that may adversely affect the production of particles during the passage through the reaction tube 310. In addition, when a gas, such as pressurized gas, is used as an oxygen source, it may also serve as a carrier for the vaporized product of precursor.

In addition, the vaporized product of precursor may be supplied to the reaction unit 300 together with a carrier gas. The carrier gas serves as a carrier as mentioned earlier, and may be supplied through a carrier gas supplying line 160.

The reaction temperature may depend on the particular type of the titania precursor. For example, the reaction temperature may be 700-1200° C. When the reaction temperature is lower than 700° C., it is difficult to perform thermal decomposition of the titania precursor and sufficient crystallization (formation) of titania particles, resulting in a drop in yield (productivity). When the reaction temperature is higher than 1200° C., the resultant particles may become crude and undergo a transition from anantase to rutile. Considering these, the reaction temperature may be 800° C. or higher, and particularly 800-1100° C.

Recovering

Then, the titania particles obtained from the reaction operation are recovered. The recovering operation comprises cooling the titania particles obtained from the reaction operation, and collecting the cooled titania particles. The cooling operation may be carried out by using a rapid cooling system 410 having a turbulence-forming section 414a provided on the flow path 413 of the titania particles as described earlier.

Particularly, the product (fluid) ejected from the reaction unit 300 contains, in addition to titania particles as a target product, a hot gas (carrier gas or the like) and vaporous materials, such as vaporous organic materials generated by thermal decomposition of the titania precursor, and maintains high temperature. For the purpose of separation and removal of such vaporous materials, the recovering operation comprises cooling the titania particles obtained from the reaction, and collecting and recovering titania particles from the cooled product. The cooling operation may be carried out by using the above-mentioned cooling system 410, i.e. the rapid cooling system 410 described hereinabove with reference to FIG. 2. In other words, the above-described rapid cooling system 410 having a turbulence-forming section 414a formed on the fluid flow path 413 is used to carry out the cooling operation. In addition, the collecting operation may be carried out by using the above-described particle collecting system 420.

The titania particles (i.e. titania carrier (support) for use in supporting a catalyst thereon) obtained in the above-described manner are porous particles prepared via chemical vapor synthesis comprising vaporizing a titania precursor, and are condensed by rapid cooling to provide a large specific surface area and ultrafine nano-scaled uniform particle size. In addition, particle agglomeration (aggregation) is prevented and an increased pore volume is obtained. Particularly, according to an embodiment, it is possible to obtain a titania carrier having a specific surface area of 100 m²/g-150 m²/g, an average pore volume of 0.1 cm³/g-0.2 cm³/g and an average particle size of 5 nm-20 nm. Therefore, the titania carrier disclosed herein has high dispersibility upon supporting a catalyst thereon. Particularly, due to such a uniform nano-scaled size, high specific surface area and an increased pore volume, a catalyst is dispersed and supported on the surface of the carrier uniformly with a broad distribution while not causing pore occlusion. As a result, the catalyst has improved characteristics to enhance nitrogen oxide removal efficiency. Also, the catalyst has excellent denitrogenation efficiency even in a low temperature range of about 200° C. Further, the process for preparing the catalyst is continuous and time efficient, thereby allowing mass production. As described above, the titania particles are collected with a high yield (yield after condensation) by virtue of the above-mentioned rapid cooling (condensation).

The titania carrier obtained by the method disclosed herein is used as a carrier (support) for supporting a catalyst for removing nitrogen oxides. Particularly, the titania carrier is used as a carrier for metal oxide catalysts, such as vanadium oxide (V₂O₅, etc.) and manganese oxide. More particularly, the titania carrier is used as a carrier for manganese oxide catalyst, and even more particularly, used for preparing the manganese oxide-titania catalyst as described below. Hereinafter, a manganese oxide-titania catalyst and a method for preparing the same, and a method for removing nitrogen oxides using the same will be described.

The method for preparing a manganese oxide-titania catalyst comprises preparing a titania carrier, mixing the titania carrier with a solution in which a manganese precursor is dissolved, and drying and calcining the resultant mixture. Preparation of the titania carrier is the same as described.

Herein, the manganese precursor is not particularly limited, as long as it contains manganese (Mn) in its molecule. Although there is no particular limitation, the manganese precursor may be at least one selected from manganese salts and organomanganese compounds. Particular examples of the manganese salts comprise manganese chloride (MnCl₂) and manganese nitrate (Mn(NO₃)₂). Additional examples of manganese salts comprise at least one selected from the group consisting of manganese acetate, manganese acetylacetonate, manganese carbonyl, manganese nitrate and hydrates thereof. Particularly, manganese acetate (Mn(CH₃COO)₂), manganese nitrate (Mn(NO₃)₂) and hydrates thereof (Mn(CH₃COO)₂.4H₂O, etc.) may be used.

Such a manganese precursor is dissolved in water (distilled water) or the like to obtain a solution in which the manganese precursor is dissolved. Next, the solution is agitated and heated to an adequate temperature (e.g. 50-70° C.). Then, the titania carrier is mixed and agitated with the manganese precursor solution, followed by drying. The drying operation may be carried out by evaporating water from the mixture by using a vacuum evaporator, and drying the evaporated mixture in a drying furnace at a temperature of 100-120° C. for 10 hours or more to accomplish complete drying.

Then, the dried mixture (dried product of titania particles+manganese precursor) is introduced to and calcined in a calcining furnace. The calcining operation may be carried out by heat treatment in a calcining furnace under air or oxygen atmosphere for at least 3 hours, particularly, 3-6 hours, while maintaining the temperature of the calcining furnace at 450-600° C. As a result of such calcining, the manganese precursor is crystallized and supported on the titania particles. More particularly, manganese oxide may be supported in an amount of 1-15 wt % based on the total weight of the catalyst (combined weight of titania+manganese oxide).

The manganese oxide-titania catalyst disclosed herein comprises manganese oxide supported on titania particles obtained by incorporating a titania carrier (particles) to a manganese precursor solution, followed by calcining. Since the manganese oxide-titania catalyst undergoes elemental rearrangement and substitution of manganese and titania during the calcining, it has an increased specific surface area, pore volume and pore diameter as compared to original titania. Particularly, the manganese oxide-titania catalyst obtained by the method disclosed herein has a specific surface area of 100 m²/g-280 m²/g and an average pore volume of 0.12 cm³/g-0.38 cm³/g. The above defined ranges of specific surface area and average pore volume are effective for removing nitrogen oxides. In addition, the manganese oxide-titania catalyst has an average particle size of 3-15 nm. Further, since the titania carrier has a high specific surface area and pore volume, manganese oxide may be supported on the titania carrier with high dispersibility. As a result, the manganese oxide-titania catalyst has excellent nitrogen oxide removal efficiency, and particularly has excellent denitrogenation efficiency in a low-temperature range.

Manganese oxide may have a different crystal type depending on the particular type of manganese precursor. For example, manganese oxide may have various crystal types, comprising MnO, MnO₂, Mn₂O₃ and Mn₃O₄, or the like, depending on the particular type of manganese precursor. According to an embodiment, the manganese oxide-titania catalyst uses manganese acetate as a manganese precursor, so that it has a specific surface area of 200 m²/g-280 m²/g and an average pore volume of 0.27 cm³/g-0.36 cm³/g. According to another embodiment, the manganese oxide-titania catalyst uses manganese nitrate as a manganese precursor, so that it has a specific surface area of 100 m²/g-200 m²/g and an average pore volume of 0.12 cm³/g-0.27 cm³/g.

The method for removing nitrogen oxides disclosed herein uses the manganese oxide-titania catalyst. Particularly, the method for removing nitrogen oxides may be carried out in a manner generally known to those skilled in the art by using the manganese oxide-titania catalyst disclosed herein as a catalyst for reduction. For example, nitrogen oxides may be removed by loading the manganese oxide-titania catalyst disclosed herein to a fixed bed reactor, and passing a gas to be treated through the fixed bed reactor. The gas to be treated contains nitrogen oxides and particular examples thereof comprise exhaust gas generated from power plants, incineration plants and various petrochemical plants.

As described above, the manganese oxide-titania catalyst disclosed herein has excellent activity so that it removes nitrogen oxides effectively even in a low-temperature range. In other words, even when the temperature during the removal of nitrogen oxides (i.e. the reaction temperature in the fixed bed reactor) is maintained at low temperature, it is possible to remove nitrogen oxides with high efficiency. Particularly, even when the reaction temperature (treatment temperature) is maintained at a low temperature of about 200° C., more particularly 100-250° C., it is possible to obtain high denitrogenation efficiency corresponding to a nitrogen oxide decomposition efficiency of 80% or higher. Particularly, the manganese oxide-titania catalyst has a high denitrogenation efficiency of 90% or more at a low temperature of 150° C.

The examples and comparative examples will now be described. The following examples are for illustrative purposes only and not intended to limit the scope of the present disclosure.

### Example 1

### Preparation of Titania (TiO₂) Carrier

Titania (TiO₂) particles are prepared by using the apparatus as shown in FIG. 1 as described below.

First, titanium tetra-iso-proxide (TTIP, Ti[OCH(CH₃)₂]₄, available from Kanto Chemical Co. Inc, Japan) is introduced as a Ti precursor to the bubbler 122 of the titania precursor supplying unit 100 of the apparatus as shown in FIG. 1, and is allowed to evaporate by maintaining the temperature at 95° C. by using an oil bath. Next, Ar gas is injected into the bubbler 122 of the titania precursor supplying unit 100 as a carrier gas at a flow rate of 0.7 L/min to convey and supply the evaporated Ti precursor to the reaction tube 310. In addition, air is introduced into the reaction tube 310 at a flow rate of 7 L/min through the oxygen supplying line 200.

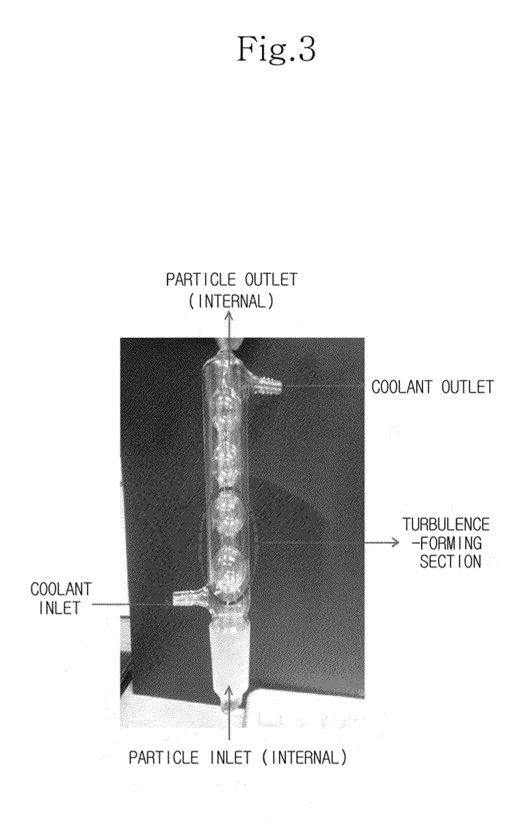

Then, the reaction tube 310 is maintained at 900° C. by using an externally warmed electric furnace to produce TiO₂ particles. After that, the fluid containing the hot TiO₂ particles produced from the reaction tube 310 are cooled to 10° C. by using the rapid cooling system 410 having a ball-like turbulence-forming section 414a as shown in FIG. 2. FIG. 3 is an actual photograph illustrating the rapid cooling system 410 used in this example. After condensing the particles in the rapid cooling system 410, the condensed TiO₂ particles are collected and recovered by using a cyclone type particle collecting system.

### Example 2

### Preparation of Manganese Oxide-Titania (Mn₂O₃—TiO₂) Catalyst

Manganese oxide is supported on the titania particles obtained as described in Example 1 obtain a Mn₂O₃—TiO₂ catalyst.

First, manganese (II) acetate (Mn(CH₃COO)₂.4H₂O) is dissolved into distilled water as a manganese precursor, and the resultant precursor solution is agitated at 65° C. for 2 hours. The titania (TiO₂) particles obtained as described in Example 1 is introduced to the precursor solution, followed by mixing and agitation for 2 hours. Then, water is evaporated by using a vacuum evaporator. Next, the resultant mixture is introduced to a drying furnace to dry it at 110° C. for about 12 hours, and then introduced to a calcining furnace to fire the dried mixture at 500° C. for 4 hours under air. In this manner, a Mn₂O₃—TiO₂ catalyst comprising TiO₂ on which Mn₂O₃ crystal phase is supported in an amount of 10.0 wt % is obtained.

### Example 3

### Preparation of Manganese Oxide-Titania (MnO₂—TiO₂) Catalyst

Example 2 is repeated, except that the manganese precursor is changed. Particularly, Example 2 is repeated, except that manganese nitrate (Mn(NO₃)₂) is used as a manganese precursor so that MnO₂ crystal phase is formed. In this manner, a MnO₂—TiO₂ catalyst comprising TiO₂ on which MnO₂ crystal phase is supported in an amount of 10.0 wt % is obtained.

### Comparative Example 1

For the comparison with the characteristics of the titania (TiO₂) particles prepared as disclosed herein, commercially available titania (TiO₂) particles (P25 available from Degussa) prepared via a liquid phase process according to the related art are provided.

### Comparative Example 2

### Preparation of Manganese Oxide-Titania (Mn₂O₃—TiO₂) Catalyst

Manganese (II) acetate (Mn(CH₃COO)₂.4H₂O) is used as a manganese precursor together with the commercially available TiO₂ particles (Degussa P25) according to Comparative Example 1 according to the conventional wet process, thereby providing a Mn₂O₃—TiO₂ catalyst comprising TiO₂ on which Mn₂O₃ crystal phase is supported in an amount of 10.0 wt %.

### Comparative Example 3

### Preparation of Manganese Oxide-Titania (MnO₂—TiO₂) Catalyst

Comparative Example 2 is repeated, except that manganese nitrate (Mn(NO₃)₂) is used as a manganese precursor together with the commercially available TiO₂ particles (Degussa P25) according to Comparative Example 1, thereby providing a MnO₂—TiO₂ catalyst comprising TiO₂ on which MnO₂ crystal phase is supported in an amount of 10.0 wt %.

### Test Example 1

The TiO₂ particles and the manganese oxide-titania catalysts comprising the TiO₂ particles on which manganese oxide is supported according to Examples 1-3 and Comparative Examples 1-3 are determined for their specific surface areas, average pore volumes, average pore diameter and average particle sizes, based on the Brunauer-Emmett-Teller (BET) method. Particularly, BET specific surface areas, average pore volumes, average pore diameters and BET-based average particle sizes are determined through nitrogen adsorption amounts at 77K by using the BET formula. The results are shown in the following Table 1.

TABLE 1
<Results of Characterization Based on BET Method>

| | Specific | Average | | |
|---|---|---|---|---|
| | surface | pore | Average pore | Average |
| | area | volume | diameter | particle size |
| | (m²/g) | (cm³/g) | (nm) | (nm) |
| Ex. 1 | 107.5 | 0.127 | 3.50 | 10.2 |
| (TiO₂) | | | | |
| Ex. 2 | 253.7 | 0.364 | 4.83 | 8.1 |
| (Mn₂O₃—TiO₂) | | | | |
| Ex. 3 | 200.1 | 0.274 | 5.30 | 8.8 |
| (MnO₂—TiO₂) | | | | |
| Comp. Ex. 1 | 52.2 | 0.276 | 19.89 | 26.9 |
| (TiO₂) | | | | |
| Comp. Ex. 2 | 49.7 | 0.259 | 43.55 | 28.2 |
| (Mn₂O₃—TiO₂) | | | | |
| Comp. Ex. 3 | 42.6 | 0.205 | 18.73 | 30.1 |
| (MnO₂—TiO₂) | | | | |

As shown in Table 1, Comparative Examples 2 and 3 comprising manganese supported on the conventional carrier of Comparative Example 1 undergo a decrease in specific surface area. On the contrary, the catalysts according to Examples 2 and 3 shows a significant increase in specific surface area by virtue of a positive effect of such an increased specific surface area of the carrier (Example 1) obtained via vapor phase synthesis disclosed herein upon the active sites of a catalyst. Particularly, the catalyst according to Example 2 has the largest specific surface area.

In addition, after supporting manganese, the catalysts according to Comparative Examples 2 and 3 undergo a decrease in specific surface area and average pore volume, while the catalysts comprising manganese supported on the carrier of Example 1 show a significant increase in average pore volume as well as specific surface area. The catalysts according to the related art using the commercially available carrier (Comparative Example 1) cause occlusion of pores due to the carrier and a decrease in specific surface area and dispersibility on the surface of carrier, resulting in a drop in nitrogen oxide removal efficiency. On the contrary, the catalyst comprising manganese supported on the carrier (Example 1) disclosed herein cause no occlusion of pores and has an increased pore volume. This means that the catalyst disclosed herein has excellent catalytic activity.

### Test Example 2

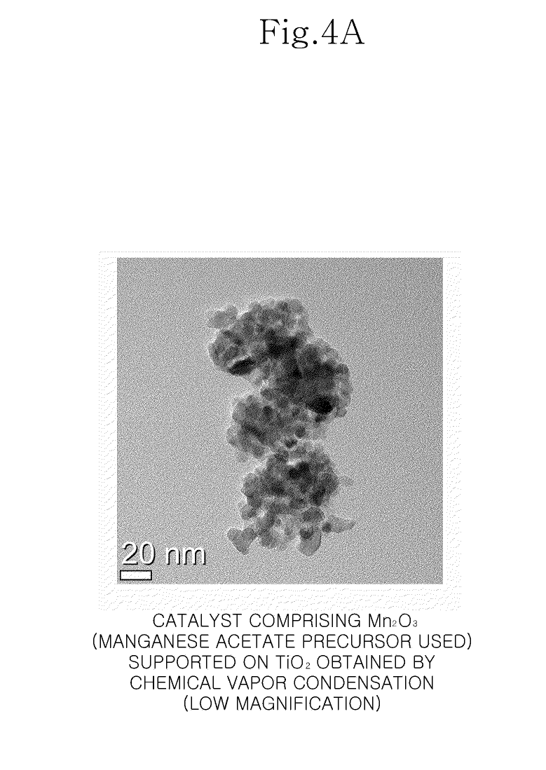

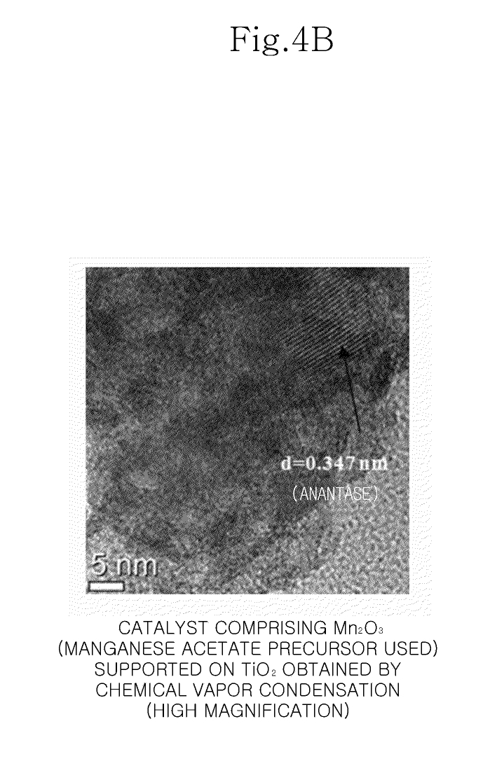

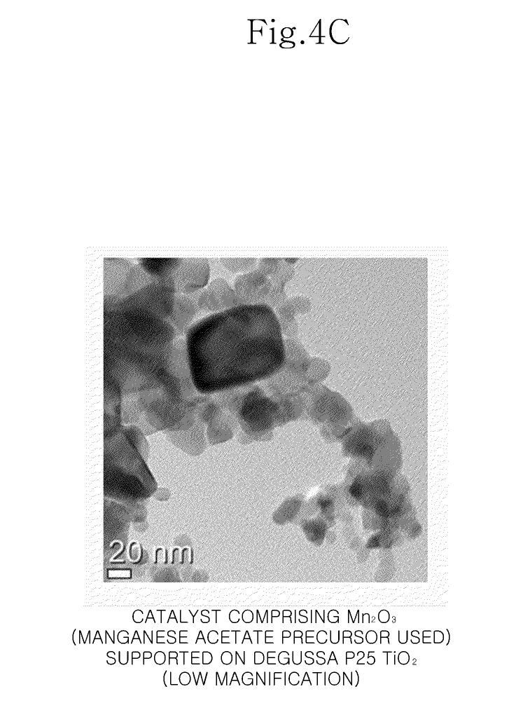

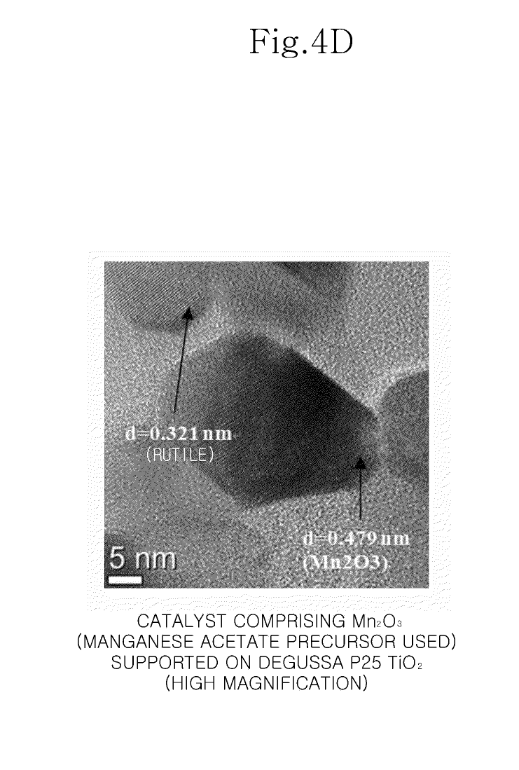

FIG. 4 is a transmission electron microscopy (TEM) image of the catalyst particles comprising manganese (II) acetate (Mn(CH₃COO)₂.4H₂O) supported on titania particles obtained by chemical vapor condensation and on the commercially available titania carrier (Degussa P25), in an amount of 10.0 wt %.

As shown in FIG. 4, the catalyst comprising manganese supported on the titania carrier (Degussa P25) shows a non-uniform primary particle size of 20 nm or more. Particularly, the image taken at a high magnification shows a rutile crystal phase and a manganese crystal phase of Mn₂O₃. On the contrary, the catalyst comprising manganese supported on the titania carrier obtained by chemical vapor condensation has a fine primary particle size of about 10 nm, and shows a botryoidal shape having densely agglomerated particles. In addition, unlike the comparative catalyst, there is no MnOₓ type crystal phase. This demonstrates that manganese is dispersed well in an amorphous phase on the surface of the titania carrier obtained by vapor phase synthesis.

### Test Example 3

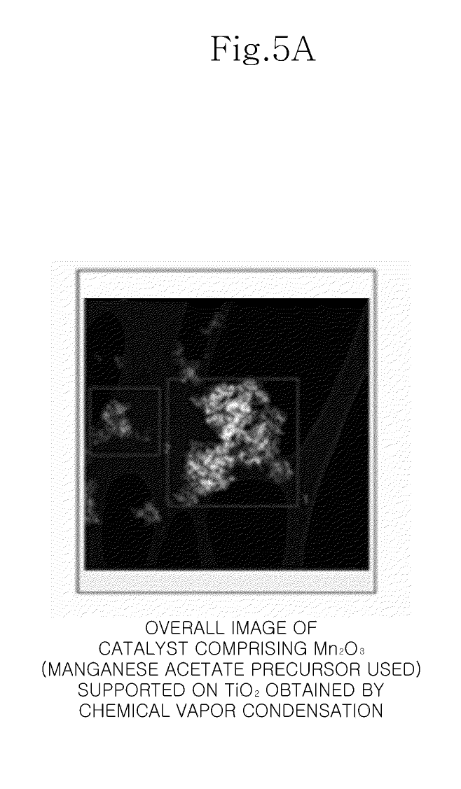

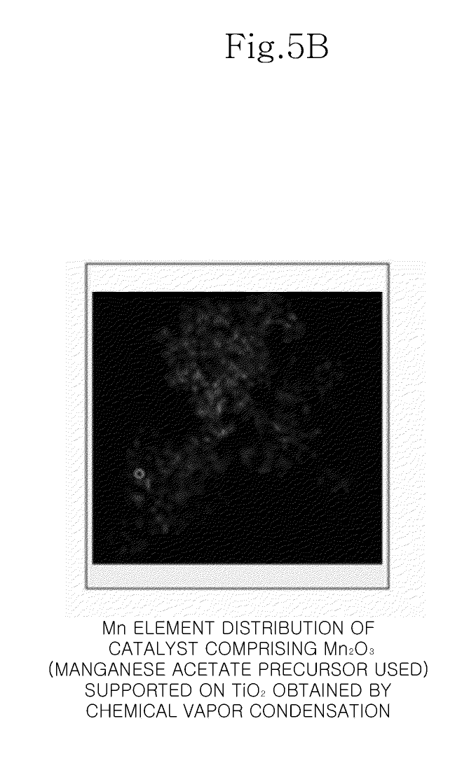

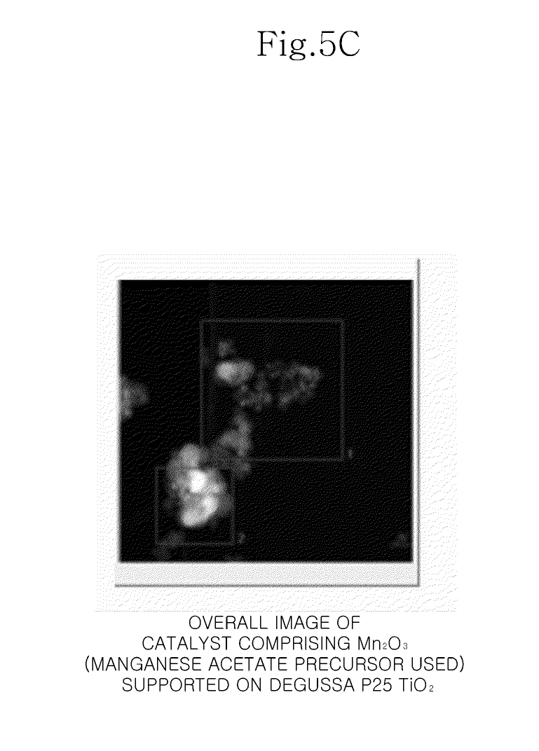

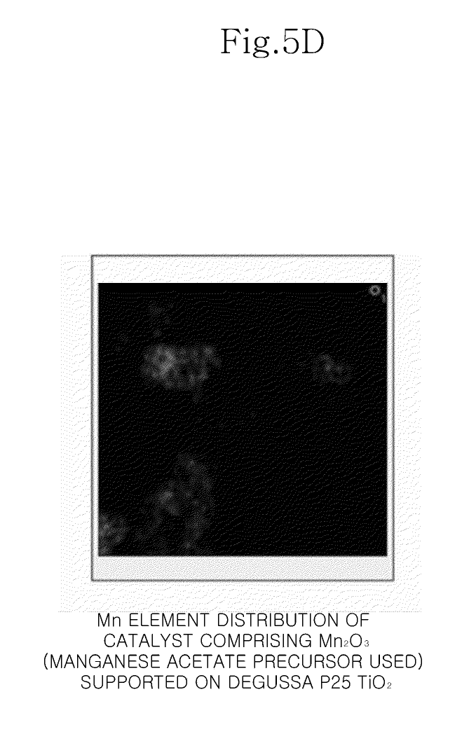

In this Example, the dispersibility of manganese is determined. FIG. 5 is an EDS mapping image of the manganese particles on different carriers based on energy spectrometry.

As shown in FIG. 5, manganese supported on the titania carrier (Degussa P25) causes partial agglomeration because manganese is not dispersed uniformly on the surface of carrier. On the contrary, manganese supported on the titania carrier obtained by vapor phase synthesis disclosed herein shows high dispersibility on the surface of carrier, and thus is dispersed uniformly thereon.

### Test Example 4

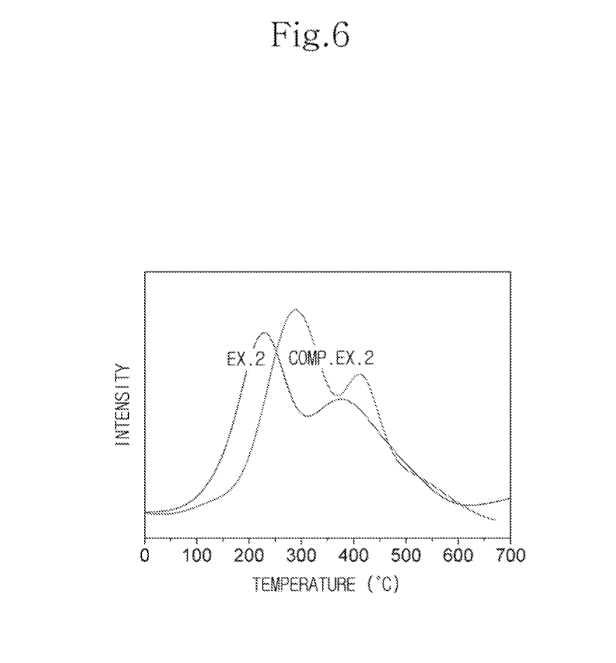

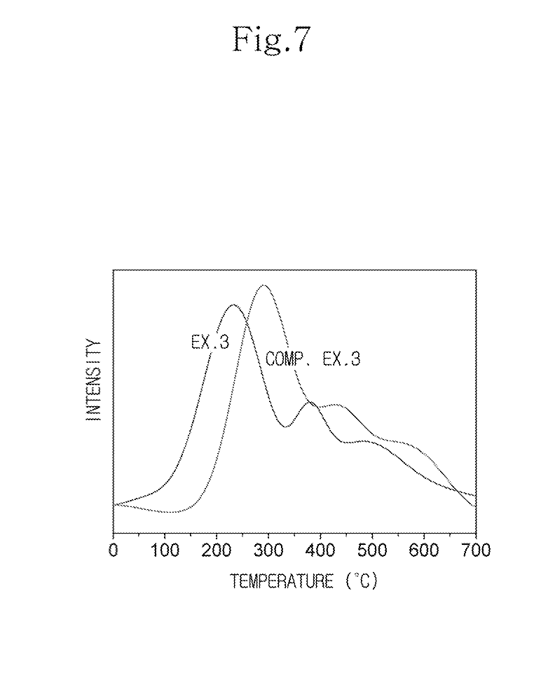

To evaluate the reduction capability of each of the catalysts comprising manganese (II) acetate (Mn(CH₃COO)₂.4H₂O) precursor or manganese nitrate (Mn(NO₃)₂) precursor supported on the titania carrier obtained by chemical vapor condensation or on the commercially available titania (Degussa P25) carrier in an amount of 10.0 wt %, hydrogen temperature-programmed reduction (H₂-TPR) is carried out. The results are shown in FIG. 6 and FIG. 7.

As shown in FIG. 6 and FIG. 7, the catalyst comprising manganese supported on the commercially available titania carrier allows initiation of reduction at low temperature regardless of the type of manganese precursor. On the contrary, the catalyst comprising manganese supported on the titania carrier obtained by vapor phase synthesis disclosed herein allows initiation of reduction at a low temperature of 100° C. or less. The catalyst comprising manganese acetate precursor supported thereon allows initiation of reduction in a relatively low temperature range regardless of the type of carrier. This suggests that use of a manganese acetate precursor causes formation of a crystal phase of Mn₂O₃, makes the resultant catalyst more sensitive to the reduction test, and affects positively on the overall nitrogen oxide removal efficiency by virtue of uniform dispersion of amorphous Mn.

### Test Example 5

To determine the activity of each manganese-titania catalyst according to Examples and Comparative Examples, nitrogen oxide removal efficiency is measured for a typical nitrogen oxide, nitrogen monoxide (NO).

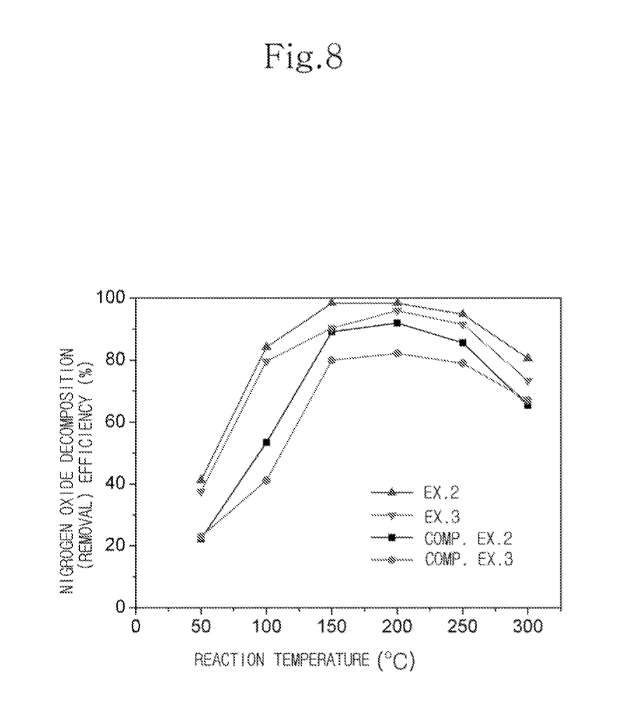

First, 1.0 g of each of the manganese-titania catalysts according to Examples 2 and 3 is charged to a fixed bed reactor, and determined for reactivity from 50° C. to 300° C. at an interval of 50° C. 500 ppm of nitrogen monoxide and 600 ppm of ammonia are passed through the reactor and the introduced nitrogen monoxide is allowed to pass through the catalyst layer at a space velocity of 30,000 h⁻¹ by using pressurized air. In addition, the concentration of nitrogen monoxide is analyzed by a gas analyzer at the top (inlet) and the bottom (outlet) of the catalyst layer. The efficiency of NO decomposition as a function of an increase in temperature is calculated, and the results are shown in FIG. 8. Further, the efficiency of NO decomposition of each of the catalysts (Comparative Examples 2 and 3) comprising manganese supported on the commercially available titania (Degussa P25) is evaluated in the same manner as described above. The results are also shown in FIG. 8.

As shown in FIG. 8, after evaluating the nitrogen oxide removal efficiency of each of the catalysts according to Ex. 2, Ex. 3, Comp. Ex. 2 and Comp. Ex. 3, the catalysts (Ex. 2 and Ex. 3) comprising manganese supported on titania obtained by vapor phase synthesis disclosed herein show a higher nitrogen oxide removal efficiency over the whole temperature range, as compared to the catalysts (Comp. Ex. 2 and Comp. Ex. 3) comprising manganese supported on the commercially available titania. Particularly, the catalyst of Ex. 2 shows the highest nitrogen oxide removal efficiency of 99% at 150° C., and shows a high nitrogen oxide removal efficiency of 82% or more even in a relative low temperature range of 100° C. or less. It is thought that a crystal phase of manganese (Mn₂O₃) is dispersed uniformly on the surface of titania obtained by vapor phase synthesis to enhance the active sites of the resultant catalyst and to cause interaction with the carrier, resulting in an increase in nitrogen oxide removal efficiency. As can be seen from the foregoing, the catalysts comprising a manganese acetate precursor supported on the titania carrier obtained by chemical vapor condensation shows excellent nitrogen oxide removal efficiency in a low temperature range.

### Test Example 6

To evaluate the nitrogen oxide removal efficiency of each of the above catalysts as a function of ammonia concentration, the efficiency is measured while varying the molar ratio of ammonia to nitrogen monoxide.

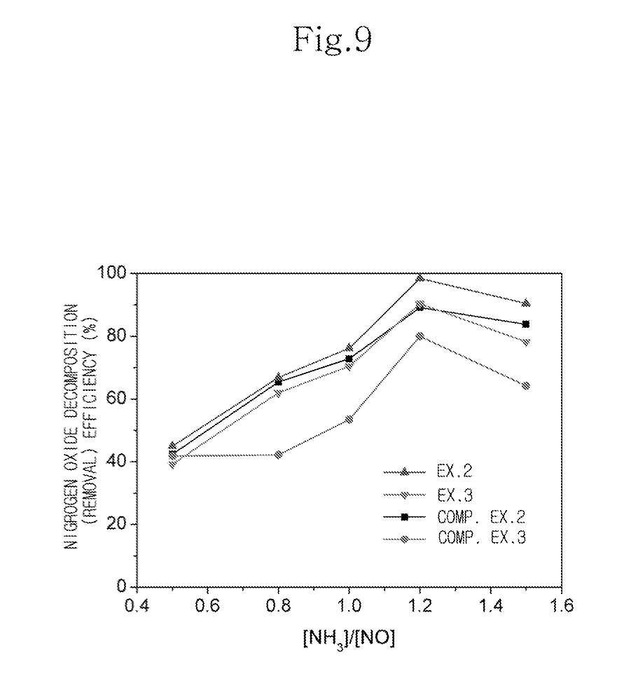

First, 1.0 g of each manganese-titania catalyst according to Examples 2 and 3 is charged to a fixed bed reactor, and determined for reactivity at 150° C. 500 ppm of nitrogen monoxide is passed through the reactor while varying the ammonia concentration from 250 ppm to 750 ppm. The introduced reaction gas is allowed to pass through the catalyst layer at a space velocity of 30,000 h⁻¹ by using pressurized air. The nitrogen monoxide decomposition efficiency is evaluated as a function of ammonia concentration and the results are shown in FIG. 9. The catalysts (Comp. Ex. 2 and Comp. Ex. 3) comprising manganese supported on the commercially available titania (Degussa P25) carrier is also determined for nitrogen monoxide removal efficiency in the same manner as described above. The results are also shown in FIG. 9.

As shown in FIG. 9, the catalyst of Ex. 3 shows a slightly lower denitrogenation efficiency compared to the catalyst of Comp. Ex. 2, depending on an increase in ammonia concentration. It is thought that a Mn₂O₃ crystal phase significantly affects nitrogen oxide removal efficiency as mentioned earlier. In addition, the catalyst of Ex. 2 shows the highest efficiency over the whole test ranges. Particularly, the catalyst of Ex. 2 shows the highest efficiency at a molar ratio of ammonia to nitrogen monoxide of 1.2. Considering that currently used power plants or incineration furnaces are operated at a ratio of 0.8, it is expected that the catalyst disclosed herein has high industrial applicability.

As can be seen from the foregoing, the titania carrier obtained via chemical vapor condensation as disclosed herein has a significantly improved specific surface area, average pore volume and dispersibility of the catalyst to be supported, and thus provides excellent denitrogenation efficiency, particularly in a low temperature range.

1. An apparatus for preparing a titania carrier, comprising:
a titania precursor supplying unit in which a titania precursor is allowed to vaporize and supplied to a reaction unit;
an oxygen supplying line through which an oxygen source is supplied to a reaction unit;
a reaction unit in which the titania precursor supplied from the titania precursor supplying unit is reacted to produce titania particles; and
a recovering unit in which the titania particles produced at the reaction unit are cooled and collected,
wherein the recovering unit comprises a cooling system for cooling the titania particles introduced from the reaction unit, and a collecting system for collecting the titania particles cooled at the cooling system, and the cooling system has a turbulence-forming section in a flow path through which the titania particles are passed.

2. The apparatus for preparing a titania carrier according to claim 1, wherein the cooling system comprises an external tube, an internal tube formed inside the external tube, and a coolant flow path through which a coolant flows formed between the internal tube and the external tube, and wherein the internal tube has a flow path through which the titania particles pass, and the flow path has a turbulence-forming section against which the titania particles introduced to the flow path bumps to form turbulence.

3. The apparatus for preparing a titania carrier according to claim 1, wherein the titania precursor supplying unit comprises a vaporization tank in which the titania precursor is heated and vaporized, a precursor supplying line through which the vaporized titania precursor at the vaporization tank is conveyed and supplied to the reaction unit, and a carrier gas injection line through which a carrier gas is introduced to the vaporization tank.

4. The apparatus for preparing a titania carrier according to claim 3, wherein the vaporization tank comprises a bubbler in which a titania precursor is received and vaporized, and an oil bath applying heat to the bubbler.

5. The apparatus for preparing a titania carrier according to claim 3, wherein the oxygen supplying line comprises a storage tank in which an oxygen source is stored, and an oxygen conveying line through which the oxygen source stored in the storage tank is conveyed, wherein the oxygen conveying line is connected to the precursor supplying line.

6. The apparatus for preparing a titania carrier according to claim 3, wherein the precursor supplying line has a constant temperature-maintaining member to prevent condensation of a titania precursor.

7. A method for preparing a titania carrier, comprising:
vaporizing a titania precursor;
reacting the vaporized titania precursor to produce titania particles; and
recovering the titania particles produced from the reacting operation,
wherein said recovering comprises cooling the titania particles produced from the reacting operation and collecting the cooled titania particles, and
said cooling is carried out by using a cooling system having a turbulence-forming section on a flow path of the titania particles from the reacting operation.

8. The method for preparing a titania carrier according to claim 7, further comprising:
providing a titania precursor supplying unit in which a titania precursor is allowed to vaporize and supplied to a reaction unit;
providing an oxygen supplying line through which an oxygen source is supplied to a reaction unit;
providing a reaction unit in which the titania precursor supplied from the titania precursor supplying unit is reacted to produce titania particles; and
providing a recovering unit in which the titania particles produced at the reaction unit are cooled and collected,
wherein the recovering unit comprises a cooling system for cooling the titania particles introduced from the reaction unit, and a collecting system for collecting the titania particles cooled at the cooling system, and the cooling system has a turbulence-forming section in a flow path through which the titania particles are passed.

9. The method for preparing a titania carrier according to claim 7, wherein said reacting is carried out while maintaining the reaction unit at a temperature of 700-1200° C.

10. A titania carrier for supporting a catalyst for removing nitrogen oxides, which has a specific surface area of 100 m²/g-150 m²/g, an average pore volume of 0.1 cm³/g-0.2 CM³/g, and an average particle size of 5 nm-20 nm.

11. (canceled)

12. A method for preparing a manganese oxide-titania catalyst for removing nitrogen oxides, comprising:
providing a titania carrier by the method as defined in claim 7; and
mixing the titania carrier with a solution in which a manganese precursor is dissolved, followed by drying and calcining.

13. The method for preparing a manganese oxide-titania catalyst for removing nitrogen oxides according to claim 12, wherein the manganese precursor is at least one selected from manganese acetate and manganese nitrate.

14. A manganese oxide-titania catalyst for removing nitrogen oxides, which comprises the titania carrier as defined in claim 10 and manganese oxide supported thereon, and has a specific surface area of 100 m²/g-280 m²/g, and an average pore volume of 0.12 cm³/g-0.38 cm³/g.

15. The manganese oxide-titania catalyst for removing nitrogen oxides according to claim 14, wherein the manganese oxide is supported in an amount of 1-15 wt % based on the total weight of the catalyst.

16. (canceled)

17. The manganese oxide-titania catalyst for removing nitrogen oxides according to claim 14, which uses manganese acetate as a manganese precursor, and has a specific surface area of 200 m²/g-280 m²/g, and an average pore volume of 0.27 cm³/g-0.36 cm³/g.

18. The manganese oxide-titania catalyst for removing nitrogen oxides according to claim 14, which uses manganese nitrate as a manganese precursor, and has a specific surface area of 100 m²/g-200 m²/g, and an average pore volume of 0.12 cm³/g-0.27 cm³/g.

19. A method for removing nitrogen oxides using the manganese oxide-titania catalyst as defined in claim 14.

20. The method for preparing a titania carrier according to claim 7, wherein the cooling system comprises an external tube, an internal tube formed inside the external tube, and a coolant flow path through which a coolant flows formed between the internal tube and the external tube, and wherein the internal tube has a flow path through which the titania particles pass, and the flow path has a turbulence-forming section against which the titania particles introduced to the flow path bumps to form turbulence.

21. The method for preparing a titania carrier according to claim 7, wherein the titania precursor supplying unit comprises a vaporization tank in which the titania precursor is heated and vaporized, a precursor supplying line through which the vaporized titania precursor at the vaporization tank is conveyed and supplied to the reaction unit, and a carrier gas injection line through which a carrier gas is introduced to the vaporization tank.

22. The method for preparing a titania carrier according to claim 7, wherein the vaporization tank comprises a bubbler in which a titania precursor is received and vaporized, and an oil bath applying heat to the bubbler
